(19) United States
(12) Patent Application Publication
(10) Pub. No.: US 2014/0099883 A1
(43) Pub. Date: Apr. 10, 2014

(54) SATELLITE COMMUNICATION SYSTEM

(71) Applicant: Robert F. Wallace, Fort Myers, FL (US)

(72) Inventor: Robert F. Wallace, Fort Myers, FL (US)

(21) Appl. No.: 14/047,939

(22) Filed: Oct. 7, 2013

Related U.S. Application Data
(60) Provisional application No. 61/710,689, filed on Oct. 6, 2012.

(51) Int. Cl. H04B 7/185

(52) U.S. Cl. CPC H04B 7/18517
USPC 455/12.1

(57) ABSTRACT

A satellite communication system comprises a wireless signal transmitter to be mounted to an outdoor satellite signal receiver and an indoor signal receiver to be connected to an output appliance and to wirelessly receive signals from the wireless signal transmitter.

### CROSS-REFERENCE TO RELATED PATENT APPLICATIONS

The present application claims priority under 35 USC 119(e) from co-pending U.S. Provisional Patent Application Ser. No. 61/710689 filed on Oct. 6, 2012 by Robert F. Wallace and entitled SATELLITE COMMUNICATION SYSTEM, the full disclosure of which is hereby incorporated by reference.

### BACKGROUND

Many of today's homes and commercial establishments receive entertainment and communicate through a wide area network across a satellite using a dish or antenna external to the residential or commercial building which is wired to one or more receiving boxes located within the building, typically adjacent to the appliance in the form of a television, computer, radio and the like. Such systems are difficult to set up and are even more difficult to modify to accommodate differently located or additional appliances within the building.

### BRIEF DESCRIPTION OF THE DRAWINGS

FIG. 1 is a schematic illustration of an example satellite communication system.

FIG. 2 is a schematic illustration of another example satellite communication system.

### DETAILED DESCRIPTION OF THE EXAMPLE EMBODIMENTS

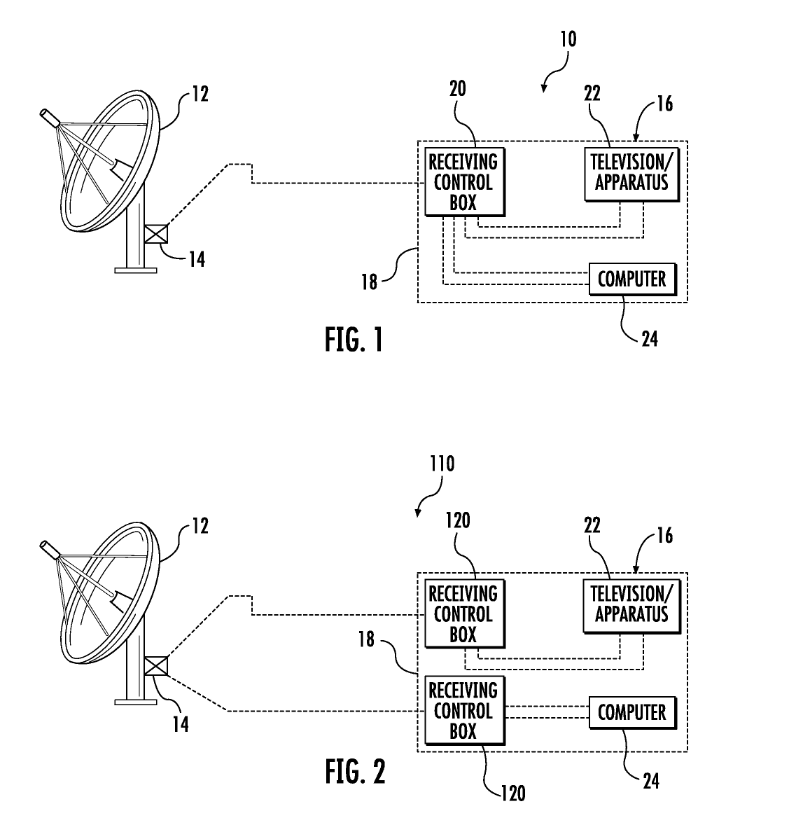

FIG. 1 schematically illustrates an example satellite communication system 10. As will be described hereafter, satellite communication system 10 facilitates communication between an outdoor satellite signal receiver and an indoor signal displaying or sounding appliance while minimizing the use of cumbersome and unsightly wiring. In many instances they may have a feasible to establish such wiring. As a result, such that communication cannot be achieved between the outdoor satellite signal receiver in the indoor signal displaying or sounding appliance.

Satellite communications system 10 comprises an outdoor satellite signal receiver 12, an outdoor signal transmitter 14, a building 16 having an external wall 18 and containing or housing an indoor signal receiver 20 and one or more output appliances 22, 24. Outdoor satellite signal receiver 12 comprises a device to receive signals from an orbiting satellite. In the example illustrated, outdoor satellite signal receiver 12 comprises one or more satellite dishes. In other implementations, outdoor satellite signal receiver 12 may comprise other devices such as antennas or structures that receive signals from a remote satellite. In one implementation, satellite signal receiver 12 is mounted on are supported by a post or other supporting structure spaced from external wall 18 of building 16. In yet other implementations, satellite signal receiver 12 is mounted on a roof of building 16 or on external wall 18 of building 16.

Outdoor signal transmitter 14 comprises a package of electronics configured to receive signals from outdoor satellite signal receiver 12 and to wirelessly transmit such signals through an across external wall 18 to one or more indoor signal receivers 20. In one implementation, outdoor signal transmitter 14 may additionally scramble or encrypt the signals being transmitted to inhibit unauthorized receipt and use of the signals that other unauthorized indoor or outdoor signal receivers. In one implementation, outdoor signal transmitter 14 may further be configured to store an official authorization code or receive an official authorization code via signal receiver 12 for comparison with a candidate authorization code received from indoor signal receiver 20. In one implementation, outdoor signal transmitter 14 may be configured to perform a handshake operation with the indoor signal receiver 12 or request authorization credentials from indoor signal receiver 20. In yet other implementations, such authorization protocols may be omitted.

Building 16 comprises a residential, industrial, institutional or commercial building having a foundation, sidewalls and a roof. For purposes of this disclosure, external wall 18 means any external outwardly facing wall of building 16 including the exterior sidewalls, the roof and the foundation of building 16. Building 16 may include multiple internal walls and multiple levels, making internal wiring difficult. Because outdoor signal transmitter 14 wirelessly transmits signals received from receiver 12 through and across external wall 18, external wall 18 is not compromised. Moreover, wiring through and within interior walls of building 16 be minimized or avoided. As a result, satellite communication system 10 is easier and less expensive to set up. Satellite communication system 10 may provide satellite signals to multiple remote locations within building 16 which may otherwise not be accessible due to wiring constraints.

Indoor signal receiver 20 comprises one or more devices configured to receive wireless signals from wireless signal transmitter 14 through external wall 18. Indoor signal receiver 20 further transmits such signals to one or more internal appliances 22, 24. In one implementation, indoor signal receiver 20 descrambles or converts the wireless signals received from transmitter 14 into a format usable by appliances 22, 24 to present such signals in a visible and/or audible manner to persons within building 16. In one implementation, indoor signal receiver 20 comprises a receiving control box from one of multiple signals or channels for presentation by the particular indoor appliance 22, 24. For example, in one implementation, receiving control box 20 is configured to allow a person to select which of many available wireless signals available from transmitter 14 or receiver 12 are actually transmitted from transmitter 14 across external wall 18. In one implementation, receiver 20 communicates the received wireless signals to appliances 22, 24 in a wired fashion. In another implementation, receiver 20 transmits the wireless signals received from transmitter 14 to one or more of appliances 22, 24 in a wireless fashion, such as through a local area network.

Appliances 22, 24 comprise devices configured to utilize signals received from receiver 20 and to present video and/or audio media generated based upon such received signals. In the example illustrated, appliance 22 comprises a television while appliance 24 comprises a computer having a display screen. In other implementations, appliances 22, 24 may comprise other audio or video presentation devices such as a smart phone, personal data assistant (PDA), flash memory player device and the like.

In operation, signals are transmitted from an orbiting satellite to receiver 12. Receiver 12 transmits such signals to outdoor wireless signal transmitter 14. Transmitter 14 transmits a wireless signals to receiver 20 through an across external wall 18. Receiver 20 further transmits signals to appliances 22, 24. In one implementation, wireless transmitter 14 and receiver 20 cooperate with one another to perform an authorization procedure using passwords, stored authorization codes and the like to ensure that signals transmitted by transmitter 14 are not misappropriated by unauthorized receivers. In one implementation, wireless transmitter 14 encrypts or scrambles such wireless signals being transmitted to receiver 20, wherein receiver 20 is configured to decode, decrypt or descramble such signals for further transmission and use by appliances 22, 24. In one implementation, receiver 20 further converts such received signals for use by appliances 22, 24.

FIG. 2 schematically illustrates satellite communication system 110, another example of satellite communication system 10. Satellite communications system 110 is similar to satellite communications system 10 except that satellite communication system 110 comprises wireless signal transmitter 114 and indoor signal receivers 120 in place of transmitter 14 and receiver 20, respectively. Those remaining components of system 110 which correspond to components of system 10 are numbered similarly.

Wireless signal transmitter 114 comprises a package of electronics configured to receive signals from outdoor satellite signal receiver 12 and to wirelessly transmit such signals through an across external wall 18 to one or more indoor signal receivers 20. Wireless signal transmitter 114 is similar to wireless signal transmitter 14 except that wireless signal transmitter 114 is configured to wirelessly transmit signals based upon signals received from receiver 12 across external wall 18 to a plurality of distinct indoor signal receivers 120 within building 16. In one implementation, wireless signal transmitter 114 transmits the same exact signals received from receiver 12. In another implementation, wireless signal transmitter 114 performs a modification of signals received from receiver 112 prior to transmitting such as converted or modified signals to receivers 120.

In one implementation, outdoor signal transmitter 114 may additionally scramble or encrypt the signals being transmitted to inhibit unauthorized receipt and use of the signals that other unauthorized indoor or outdoor signal receivers. In one implementation, outdoor signal transmitter 114 may further be configured to store an official authorization code or receive an official authorization code via signal receiver 12 for comparison with a candidate authorization code received from indoor signal receiver 120. In one implementation, outdoor signal transmitter 14 may be configured to perform a handshake operation with the indoor signal receiver 12 or request authorization credentials from indoor signal receiver 120. In yet other implementations, such authorization protocols may be omitted.

Indoor signal receivers 120 each comprise one or more devices configured to receive wireless signals from wireless signal transmitter 114 through external wall 18. Indoor signal receivers 120 further transmit such signals to one or more internal appliances 22, 24. In one implementation, indoor signal receivers 120 descramble or convert the wireless signals received from transmitter 14 into a format usable by appliances 22, 24 to present such signals in a visible and/or audible manner to persons within building 16. In one implementation, indoor signal receivers 120 each comprises a receiving control box to allow a person to choose from one of multiple signals or channels for presentation by the particular indoor appliance 22, 24. For example, in one implementation, signal receivers 120 are configured to allow a person to select which of many available wireless signals available from transmitter 114 or receiver 12 are actually transmitted from transmitter 114 across external wall 18. In one implementation, receivers 120 each communicate the received wireless signals to appliances 22, 24 in a wired fashion. In another implementation, receivers 120 transmit the wireless signals received from transmitter 114 to one or more of appliances 22, 24 in a wireless fashion, such as through a local area network. Because indoor signal receivers 120 independently receive signals from transmitter 114 and transmit such signals to their associated one or more appliances 22, 24, receivers 120 may be located at multiple locations within building 16 in close proximity to their associated appliances 22, 24, reducing and extent of wiring within building 16 and/or the distance across which wireless signals are transmitted between receivers 120 and their associated appliances 22, 24.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A satellite communication system comprising:
a wireless signal transmitter to be mounted to an outdoor satellite signal receiver;
an indoor signal receiver to be connected to an output appliance and to wirelessly receive signals from the wireless signal transmitter.

2. The system of claim 1, wherein the outdoor satellite signal receiver comprises a satellite dish.

3. The system of claim 1, wherein the indoor signal receiver is to wirelessly transmit signals to the output appliance.

4. The system of claim 1 further comprising the outdoor satellite signal receiver, wherein the outdoor satellite signal receiver physically supports the wireless signal transmitter.

5. The system of claim 4 further comprising the output appliance, wherein the output appliance physically supports the indoor signal receiver.

6. The system of claim 1, wherein the wireless signal transmitter and the indoor signal receiver are configured to wirelessly communicate across an external wall of a building.

7. The system of claim 1 further comprising a second indoor signal receiver to be connected to a second output appliance and to wirelessly receive signals from the wireless signal transmitter.

8. The system of claim 1, wherein the indoor signal receiver is configured to transmit signals to a plurality of output appliances.

9. The system of claim 1, wherein the indoor signal receiver comprises a memory storing an authorization code, wherein the wireless signal transmitter is configured to transmit signals to the indoor signal receiver or impede the transmission of signals to the indoor receiver based upon the authorization code stored in the memory.

10. The system of claim 1, wherein the wireless signal transmitter is configured to encrypt the signal being transmitted to the indoor signal receiver.

11. The system of claim 1, wherein the wireless signal transmitter and the indoor signal receiver are configured to cooperate to perform an authorization process to inhibit unauthorized indoor signal receivers from receiving usable wireless signals from transmitter 14.

12. A method comprising:
receiving signals from an orbiting satellite with an outdoor signal transmitter;
wirelessly transmitting the signals from the outdoor signal transmitter across an external wall of a building to an indoor signal receiver; and
transmitting the signals from the indoor signal receiver to an output appliance.

13. The method of claim 12 further comprising transmitting the signals from the indoor signal receiver to a second output appliance.

14. The method of claim 12 further comprising wirelessly transmitting the signals across the external wall of the building to a second indoor signal receiver.

15. The method of claim 12 further comprising:
storing an authorization code in a memory of the indoor signal receiver;
wirelessly transmitting the authorization code to the outdoor signal transmitter.

16. The method of claim 12 further comprising comparing a received authorization code from the indoor signal receiver to an official authorization code and transmitting the signals to the indoor signal receiver based upon the comparison.

17. The method of claim 12 further comprising performing an authorization process to inhibit unauthorized indoor signal receivers from receiving usable wireless signals from transmitter 14.

18. An apparatus comprising:
an outdoor signal transmitter for receiving signals from a remote orbiting satellite, the outer signal transmitter configured to wirelessly transmit the received signals through and across an external building wall to an internal signal receiver in communication with one or more output appliances.

19. The apparatus of claim 18, wherein the outdoor signal transmitter is configured to wirelessly transmit an authorization request through an across the external building wall to the internal signal receiver prior to transmitting signals from the orbiting satellite to the internal signal receiver.

20. These apparatus of claim 19, the outdoor signal transmitter is configured to compare an authorization code received from the internal signal receiver to an official authorization code and to transmit or impede transmission of signals to the indoor signal receiver based upon the comparison.
